(19) United States
(12) Patent Application Publication
(10) Pub. No.: US 2026/0244218 A1
(43) Pub. Date: Aug. 20, 2026

(54) METHODS FOR ADJUSTING SPEED, AUTONOMOUS DEVICES, AND COMPUTER-READABLE STORAGE MEDIA

(71) Applicant: SHENZHEN HANYANG TECHNOLOGY CO., LTD., Shenzhen (CN)

(72) Inventors: Yang HUANG, Shenzhen (CN); Chuwei ZHENG, Shenzhen (CN)

(21) Appl. No.: 19/657,490

(22) Filed: Apr. 24, 2026

Related U.S. Application Data
(63) Continuation of application No. PCT/CN2023/130927, filed on Nov. 10, 2023.

(30) Foreign Application Priority Data
Oct. 24, 2023 (CN) 202311389330.X
Nov. 7, 2023 (CN) 202311477083.9

(51) Int. Cl. G05D 1/65; G05D 1/606; G05D 1/622; G05D 105/00; G05D 109/10

(52) U.S. Cl. CPC G05D 1/65; G05D 1/606; G05D 1/622; G05D 2105/12; G05D 2109/10

(57) ABSTRACT

Disclosed are a method for adjusting a speed, an autonomous device, and a computer-readable storage medium. The method is applied to the autonomous device, wherein the autonomous device includes a traveling motor and a working motor, and the method includes: acquiring a present current of the working motor; determining a first speed value based on the present current of the working motor using a preset speed adjustment algorithm; and adjusting a working current of the traveling motor to cause a traveling speed value of the autonomous device to reach the first speed value.

### CROSS-REFERENCE TO RELATED APPLICATION(S)

This patent document claims priority to and benefits of PCT Application No. PCT/CN2023/130927 filed on Nov. 10, 2023, which claims priority to and benefits of Chinese Patent Application Nos. 202311389330.X, filed on Oct. 24, 2023, and 202311477083.9, filed on Nov. 7, 2023, the entire contents of each of which are hereby incorporated herein by reference.

### TECHNICAL FIELD

The present disclosure relates to the technical field of autonomous devices, and in particular to a method for adjusting a speed, an autonomous device, and a computer-readable storage medium.

### BACKGROUND

With the development of science and technology, autonomous devices are gradually known to people, and an increasing number of autonomous devices such as snow blowers are applied to people's daily work and lives. At present, the inventor has realized that parameters of a snow auger motor and a traveling motor of the snow blower are not dynamically adjusted, and the snow blower travels at a uniform speed. In consequence, frequent overcurrent of the snow auger motor/traveling motor caused by excessive load is probably caused. To be specific, snow removal efficiency and machine running stability are affected. It can be seen that the autonomous device can only work according to a speed set by a user, and cannot adjust a running speed according to a working condition, and thus flexibility of speed adjustment is reduced.

### SUMMARY

A method for adjusting a speed, an autonomous device, and a computer-readable storage medium are disclosed in embodiments of the present disclosure to improve flexibility of speed adjustment.

In a first aspect, a method for adjusting a speed is disclosed in the embodiments of the present disclosure. The method is applied to an autonomous device, where the autonomous device includes a traveling motor and a working motor, and the method includes:
acquiring a present current of the working motor;
determining a first speed value according to the present current through a preset speed adjustment algorithm; and
adjusting a working current of the traveling motor, and causing a traveling speed value of the autonomous device to reach the first speed value.

In a second aspect, an autonomous device is disclosed in the embodiments of the present disclosure. The autonomous device includes a traveling motor, a working motor, and a processor, where the processor controls the traveling motor to implement the method disclosed in the first aspect according to the working motor.

In a third aspect, a computer-readable storage medium is disclosed in the embodiments of the present disclosure. The computer-readable storage medium stores a computer program or computer instructions, where the computer program or the computer instructions, when run by a processor, implement the method disclosed in the first aspect.

In the embodiments of the present disclosure, the autonomous device including the traveling motor and the working motor acquires the present current of the working motor, determines the first speed value according to the present current of the working motor through the preset speed adjustment algorithm, adjusts the working current of the traveling motor, and causes the traveling speed value of the autonomous device to reach the first speed value. It can be seen that the traveling speed of the autonomous device may be adjusted according to the current of the working motor of the autonomous device. Thus, the flexibility of speed adjustment can be improved. In addition, the traveling speed of the autonomous device may be adjusted according to the current of the working motor of the autonomous device. Thus, overload of the autonomous device can be avoided, working efficiency, balance, and stability of the autonomous device can be improved, and power consumption of the autonomous device can be reduced.

The details in one or more embodiments of the present disclosure are set forth in the following accompanying drawings and descriptions, and other features and advantages of the present disclosure will become apparent from the description, accompanying drawings, and claims.

### BRIEF DESCRIPTION OF THE DRAWINGS

To describe the technical solutions in embodiments of the present disclosure more clearly, the accompanying drawings required for describing the embodiments are briefly introduced below. Apparently, the accompanying drawings in the following descriptions show merely some embodiments of the present disclosure, and those skilled in the art can also derive other accompanying drawings from these accompanying drawings without creative efforts.

FIG. 1 is a schematic flowchart of a method for adjusting a speed disclosed in the embodiments of the present disclosure;

FIG. 2 is a schematic flowchart of triggering acquisition of a present current of a working motor disclosed in the embodiments of the present disclosure;

FIG. 3 is a schematic diagram of a principle of a proportional integral derivative (PID) algorithm disclosed in the embodiments of the present disclosure;

FIG. 4 is a schematic flowchart of determining a first speed value through the PID algorithm disclosed in the embodiments of the present disclosure;

FIG. 5 is a schematic structural diagram of a speed adjustment apparatus disclosed in the embodiments of the present disclosure; and

FIG. 6 is a schematic structural diagram of an autonomous device disclosed in the embodiments of the present disclosure.

### DETAILED DESCRIPTION

To enable those skilled in the art to better understand the solutions of the present disclosure, the technical solutions in embodiments of the present disclosure will be clearly and comprehensively described below in conjunction with the accompanying drawings in the embodiments of the present disclosure.

A method for adjusting a speed, an autonomous device, and a computer-readable storage medium are disclosed in the embodiments of the present disclosure to improve flexibility of speed adjustment. The detailed descriptions are provided below separately.

To better understand the embodiments of the present disclosure, the related technologies of the present disclosure are first described below.

With the development of science and technology, autonomous devices are gradually known to people, and an increasing number of autonomous devices such as snow blowers are applied to people's daily work and lives. The snow blower may be provided with a snow auger and a traveling device that correspond to a snow auger motor and a traveling motor respectively. In a case of heavy snow, the snow auger motor may be stalled or may fail to push snow, the snow blower may skid, and thus the snow blower may be overloaded. In consequence, efficiency of snow removal and balance may be affected, running performance of the motors may be damaged, and a waste of electric energy of a robot may also be caused.

At present, parameters of the snow auger motor and the traveling motor of the snow blower may not be dynamically adjusted, and the snow blower may travel at a uniform speed. In consequence, frequent overcurrent of the snow auger motor/traveling motor caused by excessive load may probably be caused. To be specific, efficiency of snow removal and stability of machine running may be affected. It can be seen that the autonomous device can work according to a speed set by a user, and may not adjust a running speed according to a working condition, and thus flexibility of speed adjustment may be reduced.

To solve the above problem, the autonomous device including the traveling motor and the working motor may acquire a present current of a working motor, determine a first speed value according to the present current of the working motor through a preset speed adjustment algorithm, adjust a working current of a traveling motor, such that a traveling speed of the autonomous device is the first speed value. It can be seen that the traveling speed of the autonomous device can be adjusted according to the current of the working motor of the autonomous device, so that the flexibility of speed adjustment can be improved.

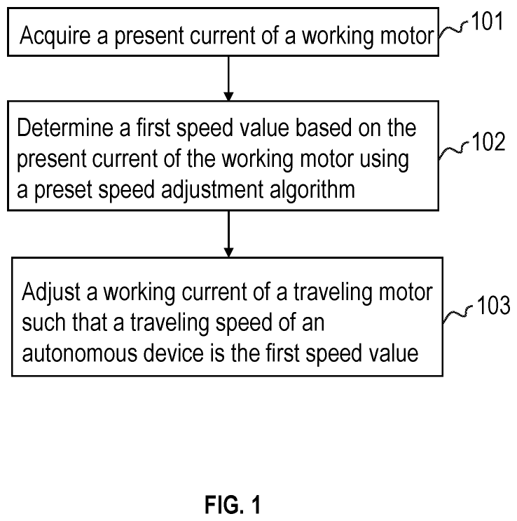

With reference to FIG. 1, a schematic flowchart of a method for adjusting a speed disclosed in the embodiments of the present disclosure is shown in FIG. 1. The method for adjusting a speed may be applied to an autonomous device, where the autonomous device may include a traveling motor and a working motor. As shown in FIG. 1, the method for adjusting a speed may include:
101, a present current of the working motor may be acquired.

The autonomous device may be provided with the traveling motor and the working motor. The traveling motor may be a motor that controls traveling or motion of the autonomous device. The working motor may be a motor that controls working of the autonomous device. It should be understood that working of the autonomous device herein may not include traveling or motion of the autonomous device, and may indicate working other than traveling or motion. The functions of the working motor may vary according to types of the autonomous devices. Illustratively, in a case where the autonomous device is the snow blower, the working motor may be a snow auger motor. In a case where the autonomous device is a lawn mower, the working motor may be a mowing motor. In a case where the autonomous device is a leaf blowing robot, the working motor may be an air blowing motor. One or more working motors of the autonomous device may be provided.

The autonomous device may acquire the present current of the working motor in real time, or may periodically acquire the present current of the working motor, or may acquire the present current of the working motor in a case of satisfying particular conditions. The present current of the working motor may be a present working current of the working motor.

In some embodiments, the autonomous device may acquire the present current of the working motor in a case where a present traveling speed of the autonomous device is greater than or equal to a minimum traveling speed of the autonomous device. The minimum traveling speed of the autonomous device may be a stored minimum traveling speed of the autonomous device. Illustratively, the minimum traveling speed of the autonomous device may be 0.01 m/s, etc.

In some embodiments, the autonomous device may first determine, in a case where the present traveling speed of the autonomous device is less than the minimum traveling speed of the autonomous device, a difference between an absolute value of the present traveling speed of the autonomous device and a second speed value; determine, in a case where the difference is less than a speed threshold, the second speed value as the first speed value; determine, in a case where the difference is not less than a speed threshold and the absolute value of the present traveling speed of the autonomous device is greater than the second speed value, a difference between the absolute value of the present traveling speed of the autonomous device and the speed threshold as the first speed value; and determine, in a case where the difference is not less than a speed threshold and the absolute value of the present traveling speed of the autonomous device is not greater than the second speed value, a sum of the absolute value of the present traveling speed of the autonomous device and the speed threshold as the first speed value. The second speed value may be a preset traveling speed value of the autonomous device.

The present traveling speed of the autonomous device may include a present traveling direction of the autonomous device and a present traveling speed value of the autonomous device. The present traveling direction of the autonomous device may be forward or backward. The present traveling direction of the autonomous device may be indicated by a positive sign or a negative sign. The positive sign may be indicated in a case where the present traveling direction of the autonomous device is forward, and the negative sign may be indicated in a case where the present traveling direction of the autonomous device is backward. Illustratively, assuming that the present traveling speed of the autonomous device is −0.3 m/s,—indicates that the present traveling direction is backward, 0.3 m/s indicates the present traveling speed value of the autonomous device, and −0.3 m/s indicates that the autonomous device moves backwards at a speed of 0.3 m/s. The present traveling speed value of the autonomous device may be the absolute value of the present traveling speed of the autonomous device.

A traveling direction of the minimum traveling speed of the autonomous device may be forward.

The autonomous device may first acquire the present traveling speed of the autonomous device, and then determine whether the present traveling speed of the autonomous device may be less than the minimum traveling speed of the autonomous device. In response to determining that the present traveling speed of the autonomous device may be greater than or equal to the minimum traveling speed of the autonomous device, it may indicate that the autonomous device travels forwards, and the present current of the working motor may be acquired. In response to determining that the present traveling speed of the autonomous device may be less than the minimum traveling speed of the autonomous device, the difference between the absolute value of the present traveling speed of the autonomous device and the second speed value may be determined. Then, whether the difference may be less than the speed threshold may be determined. In response to determining that the difference may be less than the speed threshold, it may indicate that the difference between the present traveling speed value of the autonomous device and the second speed may be small, and the second speed value may be directly determined as the first speed value. In response to determining that the difference may not be less than (i.e. greater than or equal to) the speed threshold, it may indicate that the difference between the present traveling speed value of the autonomous device and the second speed value may be big, and whether the absolute value of the present traveling speed of the autonomous device may be greater than the second speed value may be determined. In response to determining that the absolute value of the present traveling speed of the autonomous device may be greater than the second speed value, it may indicate that the present traveling speed value of the autonomous device may be greater than the second speed value. The difference between the absolute value of the present traveling speed of the autonomous device and the speed threshold may be determined as the first speed value. To be specific, the traveling speed value of the autonomous device may be decreased such that the traveling speed value of the autonomous device approaches the second speed value. In response to determining that the absolute value of the present traveling speed of the autonomous device may not be greater than (i.e. less than or equal to) the second speed value, it may indicate that the present traveling speed value of the autonomous device may be less than the second speed value. The sum of the absolute value of the present traveling speed of the autonomous device and the speed threshold may be determined as the first speed value. To be specific, the traveling speed value of the autonomous device may be increased such that the traveling speed value of the autonomous device approaches the second speed value.

In some embodiments, In response to determining that the present traveling speed of the autonomous device may be less than the minimum traveling speed of the autonomous device, whether the present traveling speed of the autonomous device may be less than a maximum reverse traveling speed of the autonomous device may continue to be determined. In response to determining that the present traveling speed of the autonomous device may be less than the maximum reverse traveling speed of the autonomous device, it may indicate that the present traveling speed value may be greater than the stored maximum backward traveling speed value. The present traveling speed of the autonomous device may be set as the maximum reverse traveling speed of the autonomous device to update the stored maximum reverse traveling speed. The maximum reverse traveling speed of the autonomous device may be the maximum autonomous device backward traveling speed stored in the autonomous device. It can be seen that the maximum reverse traveling speed of the autonomous device may not be fixed. Illustratively, the maximum reverse traveling speed of the autonomous device may be −0.3 m/s, −0.4 m/s, etc.

In response to determining that the present traveling speed of the autonomous device may not be less than (i.e. greater than or equal to) the maximum reverse traveling speed of the autonomous device, or after the present traveling speed of the autonomous device is set as the maximum reverse traveling speed of the autonomous device, the difference between the absolute value of the present traveling speed of the autonomous device and the second speed value may be determined.

In some embodiments, in a case where the present traveling speed of the autonomous device may be greater than or equal to the minimum traveling speed of the autonomous device, a time difference may be determined according to current time and a previous time stamp.

In a case where the present traveling speed of the autonomous device may be greater than or equal to the minimum traveling speed of the autonomous device, the time difference may be determined directly according to the current time and the previous time stamp, or whether the second speed value may be greater than the maximum traveling speed of the autonomous device may be determined first. In response to determining that the second speed value may be greater than the maximum traveling speed of the autonomous device, the traveling speed of the autonomous device may not reach the second speed value due to the limitation of the maximum traveling speed of the autonomous device. Thus, the second speed value may be determined as the maximum traveling speed of the autonomous device. In response to determining that the second speed value may not be greater than (i.e. less than or equal to) the maximum traveling speed of the autonomous device, it may indicate that the traveling speed of the autonomous device may reach the second speed value, and the time difference may be determined according to the current time and the previous time stamp.

After determining the time difference according to the current time and the previous timestamp, the autonomous device may acquire the present current of the working motor.

In some embodiments, whether an obstacle exists may be determined. In response to determining that the obstacle exists, the working current of the traveling motor may be adjusted, and the traveling speed of the autonomous device may be adjusted such that the traveling speed is 0. In response to determining that no obstacle exists, the present current of the working motor may be acquired.

Before the speed is adjusted, the autonomous device may determine whether an obstacle exists. In response to determining that the obstacle exists, it may indicate that the autonomous device may collide with the obstacle if the autonomous device continues traveling in the original direction. To avoid a collision between the autonomous device and the obstacle, in one case, the autonomous device may adjust the working current of the traveling motor, and adjust the traveling speed of the autonomous device such that the traveling speed is 0, such that the autonomous device stops traveling; and in another case, the autonomous device may bypass the obstacle. In this way, the collision between the autonomous device and the obstacle can be avoided without affecting the working of the autonomous device. In response to determining that no obstacle exists, the present current of the working motor may be directly acquired, or the present traveling speed of the autonomous device may be acquired. Thus, whether the present traveling speed of the autonomous device is less than the minimum traveling speed of the autonomous device may be further determined.

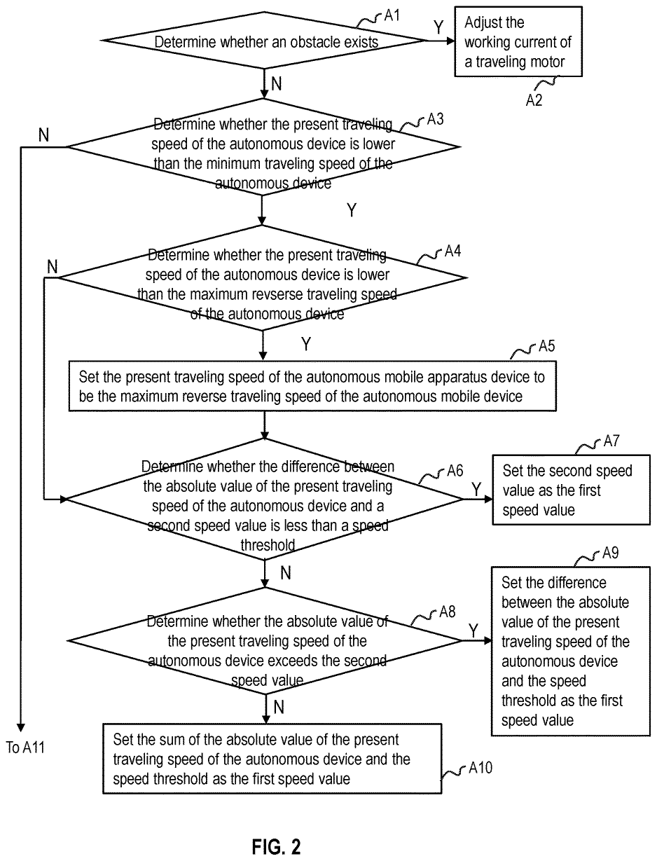

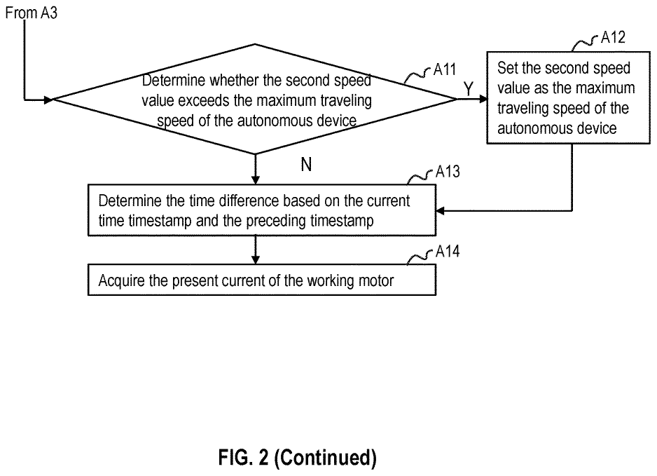

It should be understood that different embodiments described above may be combined freely. Illustratively, with reference to FIG. 2, a schematic flowchart of triggering acquisition of a present current of a working motor disclosed in the embodiments of the present disclosure is shown in FIG. 2. FIG. 2 may illustrate a case where different embodiments described above are combined. As shown in FIG. 2, the flow may include:
A1, whether an obstacle exists may be determined, step A2 may be executed in a case where the obstacle exists, and step A3 may be executed in a case where no obstacle exists.
A2, the working current of the traveling motor may be adjusted, and the traveling speed of the autonomous device may be adjusted such that the traveling speed is 0.
A3, whether the present traveling speed of the autonomous device is lower than the minimum traveling speed of the autonomous device may be determined, step A4 may be executed in a case where the present traveling speed of the autonomous device is less than the minimum traveling speed of the autonomous device, and step A11 may be executed in a case where the present traveling speed of the autonomous device is not less than (i.e. greater than or equal to) the minimum traveling speed of the autonomous device.
A4, whether the present traveling speed of the autonomous device is lower than the maximum reverse traveling speed of the autonomous device may be determined, step A5 may be executed in a case where the present traveling speed of the autonomous device is less than the maximum reverse traveling speed of the autonomous device, and step A6 may be executed in a case where the present traveling speed of the autonomous device is not less than the maximum reverse traveling speed of the autonomous device.
A5, the present traveling speed of the autonomous device may be set as the maximum reverse traveling speed of the autonomous device.
A6, whether the difference between the absolute value of the present traveling speed of the autonomous device and the second speed value is less than the speed threshold may be determined, step A7 may be executed in a case where the difference between the absolute value of the present traveling speed of the autonomous device and the second speed value is less than the speed threshold, and step A8 may be executed in a case where the difference between the absolute value of the present traveling speed of the autonomous device and the second speed value is not less than the speed threshold.
A7, the second speed value may be set as the first speed value.
A8, whether the absolute value of the present traveling speed of the autonomous device exceeds the second speed value may be determined, step A9 may be executed in a case where the absolute value of the present traveling speed of the autonomous device exceeds the second speed value, and step A10 may be executed in a case where the absolute value of the present traveling speed of the autonomous device is less than or equal to the second speed value.
A9, the difference between the absolute value of the present traveling speed of the autonomous device and the speed threshold may be set as the first speed value.
A10, the sum of the absolute value of the present traveling speed of the autonomous device and the speed threshold may be set as the first speed value.
A11, whether the second speed value exceeds the maximum traveling speed of the autonomous device may be determined, step A12 may be executed in a case where the second speed value exceeds the maximum traveling speed of the autonomous device, and step A13 may be executed in a case where the second speed value is less than or equal to the maximum traveling speed of the autonomous device.
A12, the second speed value may be set as the maximum traveling speed of the autonomous device.
A13, the time difference may be determined according to the current time timestamp and the previous timestamp.
A14, the present current of the working motor may be acquired.

The autonomous device may determine whether the obstacle exists in real time or periodically. In response to determining that the obstacle exists, the autonomous device may adjust the working current of the traveling motor, and adjust the traveling speed of the autonomous device such that the traveling speed is 0. The traveling speed of the autonomous device may be lowered to 0. The autonomous device may alternatively bypass the obstacle.

The autonomous device determining whether the obstacle exists may be understood as determining whether the obstacle exists in front of the autonomous device. The autonomous device may inspect whether the obstacle exists in front of the autonomous device through a sensor mounted in front of the autonomous device. The sensor may include, but is not limited to, an image sensor, a laser sensor, a millimeter wave sensor, and an infrared sensor.

The obstacle may be an animate obstacle or an inanimate obstacle. In response to determining that the animate obstacle exists, the working current of the traveling motor may be directly adjusted, the traveling speed of the autonomous device may be adjusted such that the traveling speed is 0, or the obstacle may be directly bypassed. In response to determining that the inanimate obstacle exists, whether a linear traveling speed of the autonomous device is greater than 0 may continue to be determined. In response to determining that the linear traveling speed of the autonomous device is greater than 0, the working current of the traveling motor may be adjusted, the traveling speed of the autonomous device may be adjusted such that the traveling speed is 0, or the obstacle may be bypassed.

In response to determining that no obstacle exists, or after the obstacle is bypassed, or In response to determining that the linear traveling speed of the autonomous device is equal to 0, the speed threshold may be acquired, and the present traveling speed of the autonomous device may be determined. The speed threshold may be a preset value. Illustratively, the speed threshold may be 0.3 m/s, etc., which is not limited herein. The present traveling speed of the autonomous device may be a speed at which the autonomous device currently travels.

Illustratively, in a case where the autonomous device travels according to wheel rolling, if the autonomous device may include a left wheel and a right wheel, the present traveling speed of the autonomous device may be an average value of linear speeds of the two wheels. It should be understood that the example may illustratively describe determination of the present traveling speed of the autonomous device, which is not limitative.

Then, whether the present traveling speed of the autonomous device is less than the minimum traveling speed of the autonomous device may continue to be determined. In response to determining that the present traveling speed of the autonomous device is less than the minimum traveling speed of the autonomous device, whether the present traveling speed of the autonomous device is less than the maximum reverse traveling speed of the autonomous device may continue to be determined. In response to determining that the present traveling speed of the autonomous device is less than the maximum reverse traveling speed of the autonomous device, it may indicate that the present traveling speed value is greater than the stored maximum backward traveling speed value. The present traveling speed of the autonomous device may be set as the maximum reverse traveling speed of the autonomous device to update the stored maximum reverse traveling speed. The maximum reverse traveling speed of the autonomous device may be the maximum autonomous device backward traveling speed stored in the autonomous device. It can be seen that the maximum reverse traveling speed of the autonomous device may not be fixed. Illustratively, the maximum reverse traveling speed of the autonomous device may be −0.3 m/s, −0.4 m/s, etc.

In response to determining that the present traveling speed of the autonomous device is not less than (i.e. greater than or equal to) the maximum reverse traveling speed of the autonomous device, or after the present traveling speed of the autonomous device is set as the maximum reverse traveling speed of the autonomous device, the difference between the absolute value of the present traveling speed of the autonomous device and the second speed value may be determined. Whether the difference between the absolute value of the present traveling speed of the autonomous device and the second speed value is less than the speed threshold may be determined. In response to determining that the difference between the absolute value of the present traveling speed of the autonomous device and the second speed value is less than the speed threshold, it may indicate that the difference between the present traveling speed value of the autonomous device and the second speed value may be small, and the second speed value may be directly determined as the first speed value. Then step 103 may be executed. The second speed value may be the preset traveling speed value of the autonomous device.

In response to determining that the difference between the absolute value of the present traveling speed of the autonomous device and the second speed value is not less than (i.e. greater than or equal to) the speed threshold, it may indicate that the difference between the present traveling speed value of the autonomous device and the second speed value may be big. Whether the absolute value of the present traveling speed of the autonomous device is greater than the second speed value may be determined. In response to determining that the absolute value of the present traveling speed of the autonomous device is greater than the second speed value, the difference between the absolute value of the present traveling speed of the autonomous device and the speed threshold may be determined as the first speed value. To be specific, the difference between the present traveling speed value of the autonomous device and the speed threshold may be big. In a case where the present traveling speed value of the autonomous device is greater than the second speed value, the traveling speed value of the autonomous device may be lowered to approach the second speed value. In response to determining that the absolute value of the present traveling speed of the autonomous device is less than the second speed value, the sum of the absolute value of the present traveling speed of the autonomous device and the speed threshold may be determined as the first speed value. To be specific, the difference between the present traveling speed value of the autonomous device and the second speed value may be big. In a case where the present traveling speed value of the autonomous device is less than the second speed value, the traveling speed value of the autonomous device may be increased to approach the second speed value. It can be seen that in a case where the difference between the present traveling speed value of the autonomous device and the second speed value may be big, the traveling speed value of the autonomous device may be adjusted to approach the second speed value instead of adjusting to the second speed value at one time. Thus, the speed may be adjusted in stages. The traveling speed value may be understood as the value of the traveling speed.

In some cases, the difference between the absolute value of the present traveling speed of the autonomous device and the second speed value may be directly compared with the speed threshold. In another case, an absolute value of the difference between the absolute value of the present traveling speed of the autonomous device and the second speed value may be determined first, and then the absolute value of the difference may be compared with the speed threshold. In this case, step A6 may be replaced by the following step of determining whether the absolute value of the difference between the absolute value of the present traveling speed of the autonomous device and the second speed value is less than the speed threshold. Step A7 may be executed in a case where the absolute value of the difference between the absolute value of the present traveling speed of the autonomous device and the second speed value is less than the speed threshold. Step A8 may be executed in a case where the difference between the absolute value of the present traveling speed of the autonomous device and the second speed value is not less than an absolute value of the speed threshold.

In response to determining that the present traveling speed of the autonomous device is not less than (i.e. greater than or equal to) the minimum traveling speed of the autonomous device, whether the second speed value is greater than a maximum traveling speed of the autonomous device may continue to be determined. In response to determining that the second speed value is greater than the maximum traveling speed of the autonomous device, the traveling speed of the autonomous device may not reach the second speed value due to the limitation of the maximum traveling speed of the autonomous device. Thus, the second speed value may be set as the maximum traveling speed of the autonomous device. In response to determining that the second speed value is not greater than (i.e. less than or equal to) the maximum traveling speed of the autonomous device, or after the second speed value is set as the maximum traveling speed of the autonomous device, it may indicate that the traveling speed of the autonomous device may reach the second speed value. The time difference may be determined according to the current time and the previous timestamp, and the current time may be updated as the previous timestamp. Then the present current of the working motor may be acquired. The maximum traveling speed of the autonomous device may be the maximum autonomous device forward traveling speed stored in the autonomous device. It can be seen that the maximum traveling speed of the autonomous device may not be fixed. Illustratively, the maximum traveling speed of the autonomous device may be 0.3 m/s, 0.4 m/s, etc.

It should be understood that the flow shown in FIG. 2 is to illustratively describe a trigger condition for acquiring the present current of the working motor, and may not be limitative of the specific trigger condition. Illustratively, steps A1 and A2 may not be executed. Illustratively, steps A3-A10 may not be executed. In this case, if a determination result in step A1 is NO, step A11 may be directly executed. Illustratively, steps A4 and A5 may not be executed. In this case, if a determination result in step A3 is yes, step A6 may be directly executed. Illustratively, steps A11 and A12 may not be executed. In this case, if a determination result in step A3 is NO, step A13 may be directly executed. Illustratively, step A13 may not be performed. Illustratively, steps A3-A13 may not be executed. In this case, if a determination result in step A1 is NO, step A14 may be directly executed. Illustratively, steps A1-A13 may not be performed.

As shown in FIG. 2, in a case where the present traveling speed of the autonomous device is less than the minimum traveling speed of the autonomous device, the difference between the absolute value of the present traveling speed of the autonomous device and the second speed value may be determined. In a case where the difference is less than the speed threshold, the second speed value may be determined as the first speed value. In a case where the difference is not less than the speed threshold and the absolute value of the present traveling speed of the autonomous device is greater than the second speed value, the difference between the absolute value of the present traveling speed of the autonomous device and the speed threshold may be determined as the first speed value. In a case where the difference is not less than the speed threshold and the absolute value of the present traveling speed of the autonomous device is not greater than the second speed value, the sum of the absolute value of the present traveling speed of the autonomous device and the speed threshold may be determined as the first speed value. After the first speed value is determined, step 103 may be executed.

It may be seen that the first speed value may be determined through step 102 or may be determined in the above manner. The methods to determine the first speed value may be different in different cases. In a case where use of the preset speed adjustment algorithm is satisfied, the first speed value may be determined through the preset speed adjustment algorithm. In a case where use of the preset speed adjustment algorithm is not satisfied, the first speed value may be determined through other methods. Thus, the speed can be adjusted in different cases, and the flexibility of speed adjustment can be improved. In addition, an application range of the speed adjustment can also be expanded, and a condition where speed adjustment is restricted to a single case may be avoided.

In some embodiments, the speed value of the traveling motor may alternatively be adjusted according to environment information. To be specific, steps 101-103 may be executed. In a case where the autonomous device may be the snow blower, a thickness of snow may be determined, and then a traveling speed value of the snow blower may be adjusted according to the thickness of the snow. The thickness of the snow may be determined through a vision sensor, radar, etc., or may be determined through a load condition of the snow auger corresponding to the snow auger motor. The thickness of the snow may be determined before or when snow is removed through the snow blower.
102, the first speed value may be determined according to the present current of the working motor through the preset speed adjustment algorithm.

The first speed value may be determined according to the present current of the working motor through the preset speed adjustment algorithm after the present current of the working motor is acquired. The preset speed adjustment algorithm may be a proportional integral derivative (PID) algorithm, etc.

In some embodiments, in a movement process of the autonomous device, whether the autonomous device needs to turn may be determined. In response to determining that the autonomous device does not need to turn, step 102 may be executed. In response to determining that the autonomous device needs to turn, since a turning speed may be low when the autonomous device turns in situ, no overcurrent of the working motor may exist. To be specific, parameter adjustment may be omitted, and thus step 102 may be skipped.

In some embodiments, the autonomous device may determine a speed adjustment proportion according to the present current of the working motor through the preset speed adjustment algorithm, and the first speed value may be determined according to the speed adjustment proportion and the present traveling speed of the autonomous device.

In some embodiments, in a case where the speed adjustment proportion is greater than or equal to 0, and the present current of the working motor is greater than an initial current of the working motor or the present traveling speed of the autonomous device is greater than an initial traveling speed of the autonomous device, the first speed value may be determined according to the speed adjustment proportion and the present traveling speed of the autonomous device.

In some embodiments, in a case where the speed adjustment proportion is less than 0, the first speed value may be determined according to the minimum traveling speed of the autonomous device. In a case where the speed adjustment proportion is greater than or equal to 0, the present current of the working motor is not greater than an initial current of the working motor, the present traveling speed of the autonomous device is not greater than an initial traveling speed of the autonomous device, and the present traveling speed of the autonomous device is less than an activation speed of the autonomous device, the second speed value may be determined as the first speed value. In a case where the speed adjustment proportion is greater than or equal to 0, the present current of the working motor is not greater than an initial current of the working motor, the present traveling speed of the autonomous device is not greater than an initial traveling speed of the autonomous device, and the present traveling speed of the autonomous device is not less than an activation speed of the autonomous device, the activation speed of the autonomous device may be determined as the first speed value.

The autonomous device may first determine the speed adjustment proportion according to the present current of the working motor through the preset speed adjustment algorithm. Then, the autonomous device may determine the first speed value directly according to the speed adjustment proportion and the present traveling speed of the autonomous device. Alternatively, whether the speed adjustment proportion is less than 0 may be first determined. In response to determining that the speed adjustment proportion is greater than or equal to (i.e. not less than) 0, whether the present current of the working motor is greater than the initial current of the working motor, or whether the present traveling speed of the autonomous device is greater than the initial traveling speed of the autonomous device or a ratio of the initial traveling speed of the autonomous device to the speed adjustment proportion may be determined. In response to determining that the present current of the working motor is greater than the initial current of the working motor or the present traveling speed of the autonomous device is greater than the initial traveling speed of the autonomous device or the ratio of the initial traveling speed of the autonomous device to the speed adjustment proportion, the first speed value may be determined according to the speed adjustment proportion and the present traveling speed of the autonomous device. In response to determining that the speed adjustment proportion is less than 0, the autonomous device may determine the first speed value according to the minimum traveling speed of the autonomous device. In response to determining that the present current of the working motor is not greater than (i.e. less than or equal to) the initial current of the working motor and the present traveling speed of the autonomous device is not greater than (i.e. less than or equal to) the initial traveling speed of the autonomous device or the ratio of the initial traveling speed of the autonomous device to the speed adjustment proportion, whether the present traveling speed of the autonomous device is less than the activation speed of the autonomous device may be determined. In response to determining that the present traveling speed of the autonomous device is less than the activation speed of the autonomous device, the second speed value may be determined as the first speed value. In response to determining that the present traveling speed of the autonomous device is not less than the activation speed of the autonomous device, the activation speed of the autonomous device may be determined as the first speed value.

In some embodiments, a third speed value may be determined according to the speed adjustment proportion and the present traveling speed of the autonomous device. In a case where the third speed value is less than or equal to the second speed value and greater than or equal to the minimum traveling speed of the autonomous device, the third speed value may be determined as the first speed value. In a case where the third speed value is greater than the second speed value, the second speed value may be determined as the first speed value. In a case where the third speed value is less than the minimum traveling speed of the autonomous device, the first speed value may be determined according to the minimum traveling speed of the autonomous device.

The autonomous device may first determine the third speed value according to the speed adjustment proportion and the present traveling speed of the autonomous device. Then, the autonomous device may directly determine the third speed value as the first speed value, or may first determine whether the third speed value is greater than the second speed value. In a case where the third speed value is less than or equal to (i.e. not greater than) the second speed value, whether the third speed value is less than the minimum traveling speed of the autonomous device may continue to be determined. In response to determining that the third speed value is greater than or equal to the minimum traveling speed of the autonomous device, the third speed value may be determined as the first speed value. In response to determining that the third speed value is greater than the second speed value, the second speed value may be determined as the first speed value. In a case where the third speed value is less than the minimum traveling speed of the autonomous device, the first speed value may be determined according to the minimum traveling speed of the autonomous device.

In some embodiments, in a case where the time difference is greater than 0 and less than or equal to 1, the first speed value may be determined according to the present current of the working motor through the preset speed adjustment algorithm. In a case where the time difference is equal to 0, the second speed value may be determined as the first speed value.

After the present current of the working motor is acquired, the first speed value may be directly determined according to the present current of the working motor through the preset speed adjustment algorithm. Alternatively, whether the present current of the working motor is equal to 0 may be first determined. In response to determining that the present current of the working motor is not equal to 0, whether the time difference is greater than 1 may be determined. In response to determining that the time difference is less than or equal to (i.e. not greater than) 1, the first speed value may be determined according to the present current of the working motor through the preset speed adjustment algorithm. In response to determining that the time difference is equal to 0, the second speed value may be determined as the first speed value.

It should be understood that different embodiments described above may be combined freely, and the specific combination method may not be limited.

The description is provided below with the preset speed adjustment algorithm as the PID algorithm as an example.

In a case where the preset speed adjustment algorithm is the PID algorithm, the first speed value may be determined according to the present current of the working motor, a steady-state current of the working motor, and a current control range of the working motor through the PID algorithm.

The steady-state current of the working motor may be a value configured to steady the current of the working motor. PID control may act to steady the current of the working motor to a steady value, i.e. the steady-state current of the working motor.

The current control range of the working motor may be a current range that allows the current of the working motor to be steady. Illustratively, in a case where the autonomous device works, the current of the working motor may be steadied within a range of (0, 30 A], and the current control range of the working motor may be 30 A. Illustratively, in a case where the autonomous device works, the current of the working motor may be steadied within a range of (10, 30 A], and the current control range of the working motor may be 20 A.

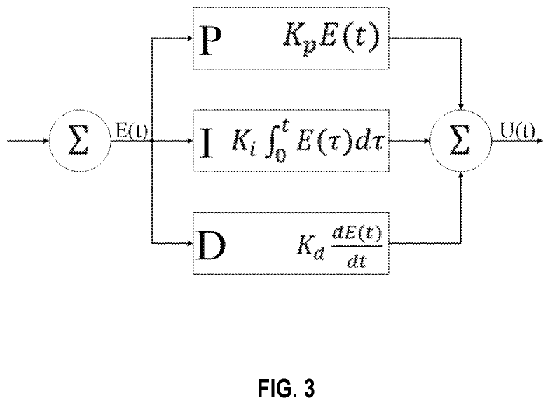

With reference to FIG. 3, a schematic diagram of a principle of a PID algorithm disclosed in the embodiments of the present disclosure is shown in FIG. 3. As shown in FIG. 3, output U(t) of the PID algorithm may be expressed as follows:

$$U ( t ) = {K}_{p} E ( t ) + {K}_{i} {\int }_{0}^{t} E ( τ ) d τ + {K}_{d} \frac{dE ( t )}{dt}$$

In the formula, E (t) denotes a proportion,

$${\int }_{0}^{t} E ( τ ) d τ$$

denotes an integral of the proportion,

$$\frac{dE ( t )}{dt}$$

denotes a derivative of the proportion, Kₚ denotes a proportional coefficient, Kᵢ denotes an integral coefficient, K_{d} denotes a derivative coefficient, and dt denotes a time difference. It can be seen that the output of the PID algorithm is a weighted sum of the proportion, the integral, and the derivative.

The speed adjustment proportion may be first determined according to the present current of the working motor through the PID algorithm. Then, the first speed value may be determined according to the speed adjustment proportion and the present traveling speed of the autonomous device.

In response to determining the speed adjustment proportion, a proportional result of the PID algorithm may be first determined according to the present current of the working motor. Then, a derivative result of the PID algorithm may be determined according to the proportional result of the PID algorithm. An integral result of the PID algorithm may be determined according to the proportional result of the PID algorithm, and the speed adjustment proportion may be further determined according to the proportional result, derivative result, and integral result of the PID algorithm. The proportional result of the PID algorithm is E (t) described above, the integral result of the PID algorithm is

$${\int }_{0}^{t} E ( τ ) d τ$$

described above, and une derivative result of the PID algorithm is

$$\frac{dE ( t )}{dt}$$

described above.

Illustratively, the proportional result E (t) of the PID algorithm may be expressed as follows:

$$E ( t ) = {( \frac{A - B}{C} )}^{D}$$

In the formula, A denotes the present current of the working motor, B denotes the steady-state current of the working motor, C denotes the current control range of the working motor, and D denotes a power constant, which is a given value.

It should be understood that the above formula is to illustratively describe determination of the proportional result of the PID algorithm according to the present current of the working motor, the steady-state current of the working motor, and the current control range of the working motor, which is not limitative. For example, the proportional result of the PID algorithm may be determined according to the present current of the working motor, the steady-state current of the working motor, and the current control range of the working motor through various transformed formulas of the above formula.

In one case, the speed adjustment proportion may be U(t). In another case, the speed adjustment proportion may be 1-U(t). The speed adjustment proportion may be greater than 0, less than 0, or equal to 0.

The first speed value may be a product of the speed adjustment proportion and the absolute value of the present traveling speed of the autonomous device, or a ratio of the absolute value of the present traveling speed of the autonomous device to the speed adjustment proportion, or another value determined according to the speed adjustment proportion and the absolute value of the present traveling speed of the autonomous device.

In some embodiments, after the present current of the working motor is acquired, whether the present current of the working motor is within a threshold range may be first determined. In response to determining that the present current of the working motor is within the threshold range, the first speed value may be determined according to the present current of the working motor through the PID algorithm. In response to determining that the present current of the working motor is out of the threshold range, no processing may be performed, or the current of the traveling motor may be adjusted such that the traveling speed of the autonomous device is lowered to 0.

Illustratively, assuming that the autonomous device is the snow blower, the current generated in a case where the snow auger motor is unloaded may be 10 A, and the current generated in an overcurrent condition of the snow auger motor may be 60 A, it may be expected that the current may be steadied within the range of 30 A. When the current of the snow auger motor is 30 A or lower and the traveling speed of the autonomous device does not reach the second speed value, the traveling speed value of the autonomous device may be increased. The smaller the current is, the more rapid the acceleration is. In a case where the current of the snow auger motor is within a range of 30 A-50 A, the traveling speed value of the autonomous device may be lowered by controlling the current of the working motor. Thus, the current of the snow auger motor may be steadied at 30 A, and the greater the current is, the higher the acceleration of deceleration is. In a case where the current of the snow auger motor exceeds 50 A, the traveling speed value of the autonomous device may be lowered to 0 to avoid overcurrent of the snow rolling motor. After the traveling speed value of the snow blower is lowered, less snow may be rolled in per unit time, and less snow may be thrown out by the snow rolling motor, so that the load of the snow auger motor can be reduced. In this case, the steady-state current of the working motor is 30 A, the current control range of the working motor is 30 A, and the threshold range is (0, 50].

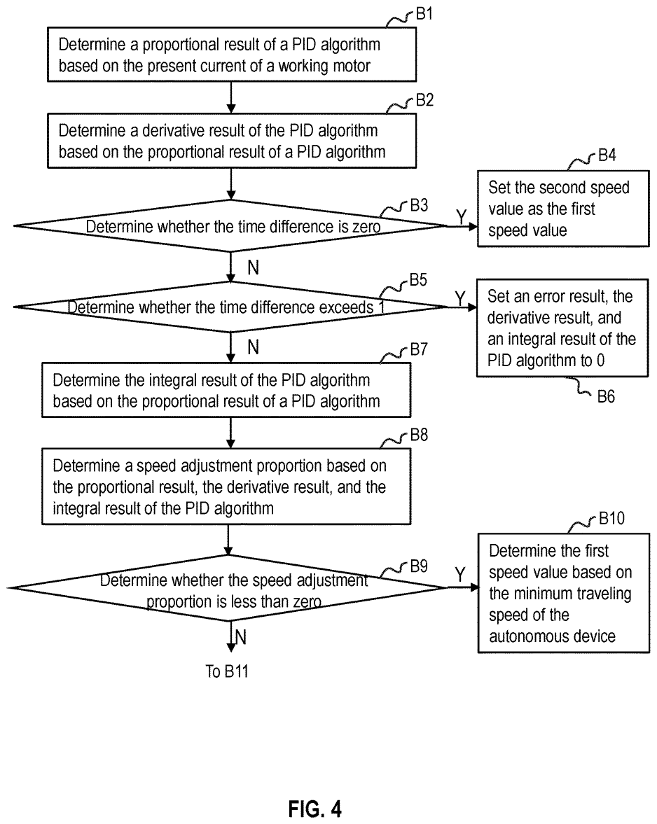

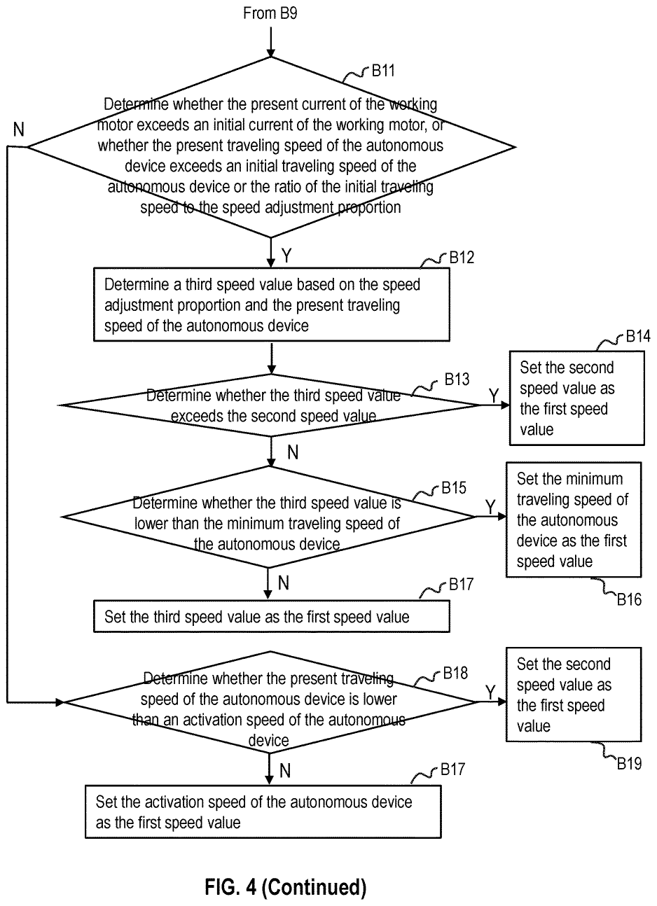

Illustratively, with reference to FIG. 4, a schematic flowchart of determining a first speed value through the PID algorithm disclosed in the embodiments of the present disclosure is shown in FIG. 4. As shown in FIG. 4, the flow may include:
B1, the proportional result of the PID algorithm may be determined according to the present current of the working motor.
B2, the derivative result of the PID algorithm may be determined according to the proportional result of the PID algorithm.
B3, whether the time difference is equal to 0 may be determined, step B4 may be executed in a case where the time difference is equal to 0, and step B5 may be executed in a case where the time difference is greater than 0.
B4, the second speed value may be determined as the first speed value.
B5, whether the time difference exceeds 1 may be determined, step B6 may be executed in a case where the time difference exceeds 1, and step B7 may be executed in a case where the time difference is less than or equal to 1.
B6, an error result, the derivative result, and the integral result of the PID algorithm may be set to 0.
B7, the integral result of the PID algorithm may be determined according to the proportional result of the PID algorithm.
B8, the speed adjustment proportion may be determined according to the proportional result, the derivative result, and the integral result of the PID algorithm.
B9, whether the speed adjustment proportion is less than 0 may be determined, step B10 may be executed in a case where the speed adjustment proportion is less than 0, and step B11 may be executed in a case where the speed adjustment proportion is greater than or equal to 0.
B10, the first speed value may be determined according to the minimum traveling speed of the autonomous device.
B11, whether the present current of the working motor exceeds the initial current of the working motor, or whether the present traveling speed of the autonomous device exceeds the initial traveling speed of the autonomous device or the ratio of the initial traveling speed to the speed adjustment proportion may be determined, step B12 may be executed if yes, and step B18 may be executed if no.
B12, the third speed value may be determined according to the speed adjustment proportion and the present traveling speed of the autonomous device.
B13, whether the third speed value is greater than the second speed value may be determined, step B14 may be executed in a case where the third speed value is greater than the second speed value, and step B15 may be executed in a case where the third speed value is less than or equal to the second speed value.
B14, the second speed value may be determined as the first speed value.
B15, whether the third speed value is lower than the minimum traveling speed of the autonomous device may be determined, step B16 may be executed in a case where the third speed value is lower than the minimum traveling speed of the autonomous device, and step B17 may be executed in a case where the third speed value is greater than or equal to the minimum traveling speed of the autonomous device.
B16, the first speed value may be determined according to the minimum traveling speed of the autonomous device.
B17, the third speed value may be determined as the first speed value.
B18, whether the present traveling speed of the autonomous device is lower than the activation speed of the autonomous device may be determined, step B19 may be executed if yes, and step B20 may be executed if no.
B19, the second speed value may be determined as the first speed value.
B20, the activation speed of the autonomous device may be determined as the first speed value.

After the present current of the working motor is acquired, the proportional result of the PID algorithm may be first determined according to the present current of the working motor, and the derivative result of the PID algorithm may be determined according to the proportional result of the PID algorithm. Then, whether the time difference is equal to 0 may be determined. In response to determining that the time difference is equal to 0, it may indicate that the current time is identical to the previous timestamp, and the second speed value may be directly determined as the first speed value. In response to determining that the time difference is greater than 0, whether the time difference is greater than 1 may continue to be determined. In response to determining that the time difference is greater than 1, it may indicate that a time interval between the current time and the previous timestamp is large, and the previous timestamp does not provide a reliable reference. The error result, the derivative result, and the integral result of the PID algorithm may be directly set to 0. In response to determining that the time difference is less than or equal to 1, the integral result of the PID algorithm may be determined according to the proportional result of the PID algorithm. After the integral result of the PID algorithm is determined, whether an absolute value of the integral result of the PID algorithm is greater than an integral upper limit may be first determined. In response to determining that the absolute value of the integral result of the PID algorithm is greater than the integral upper limit, the integral upper limit may be determined as a final integral result of the PID algorithm, and thus the final integral result of the PID algorithm may be prevented from being too large.

Illustratively, assuming that an integral interval is 0-0.5, the integral result of the PID algorithm is (−2.25)*0.5=−1.125, and the absolute value 1.125 of the integral result of the PID algorithm is greater than the integral upper limit 0.5. Thus, the final integral result of the PID algorithm is 0.5.

The speed adjustment proportion may be determined according to the proportional result, the derivative result, and the integral result (or the final integral result) of the PID algorithm. Then, whether the speed adjustment proportion is less than 0 may be determined. In response to determining that the speed adjustment proportion is less than 0, the first speed value may be determined according to the minimum traveling speed of the autonomous device. A product of the minimum traveling speed of the autonomous device and N may be determined as the first speed value. N may be a value greater than or equal to 1. Illustratively, N may be 2 or a value greater than 2.

In response to determining that the speed adjustment proportion is greater than or equal to 0, whether the present current of the working motor is greater than the initial current of the working motor, or whether the present traveling speed of the autonomous device is greater than the initial traveling speed of the autonomous device or the ratio of the initial traveling speed to the speed adjustment proportion may continue to be determined. In response to determining that the present current of the working motor is greater than the initial current of the working motor, or the present traveling speed of the autonomous device is greater than the initial traveling speed of the autonomous device or the ratio of the initial traveling speed to the speed adjustment proportion, the third speed value may be determined according to the speed adjustment proportion and the present traveling speed of the autonomous device. A product of the speed adjustment proportion and the absolute value of the present traveling speed of the autonomous device may be determined as the third speed value. Then, whether the third speed value is greater than the second speed value may be determined. In response to determining that the third speed value is greater than the second speed value, the second speed value may be determined as the first speed value, and then step 103 may be executed. In response to determining that the third speed value is less than or equal to the second speed value, whether the third speed value is less than the minimum traveling speed of the autonomous device may continue to be determined. In response to determining that the third speed value is less than the minimum traveling speed of the autonomous device, it may indicate that the third speed value is too small. Thus, the first speed value may be determined according to the minimum traveling speed of the autonomous device. In response to determining that the third speed value is greater than or equal to the minimum traveling speed of the autonomous device, the third speed value may be determined as the first speed value. Reference can be made to the above related descriptions for the detailed description of determining the first speed value according to the minimum traveling speed of the autonomous device. The initial current of the working motor may be a current of the working motor generated at the beginning of present working of the autonomous device. The initial traveling speed of the autonomous device may be the traveling speed generated at the beginning of present working of the autonomous device.

In response to determining that the present current of the working motor is not greater than the initial current of the working motor and the present traveling speed of the autonomous device is not greater than the initial traveling speed of the autonomous device or the ratio of the initial traveling speed to the speed adjustment proportion, whether the present traveling speed of the autonomous device is less than the activation speed of the autonomous device may be repeatedly assessed. In response to determining that the present traveling speed of the autonomous device is less than the activation speed of the autonomous device, the second speed value may be determined as the first speed value. In response to determining that the present traveling speed of the autonomous device is not less than the activation speed of the autonomous device, the activation speed of the autonomous device may be determined as the first speed value. The activation speed of the autonomous device may be a traveling speed attained by the autonomous device over a time taken from when the autonomous device receives an activation instruction to when activation is completed.

As shown in FIG. 4, when the speed adjustment proportion is less than 0, the first speed value may alternatively be determined according to the minimum traveling speed of the autonomous device; when the speed adjustment proportion is greater than or equal to 0, the present current of the working motor is not greater than the initial current of the working motor, the present traveling speed of the autonomous device is not greater than the initial traveling speed of the autonomous device, and the present traveling speed of the autonomous device is less than the activation speed of the autonomous device, the second speed value may alternatively be determined as the first speed value; and when the speed adjustment proportion is greater than or equal to 0, the present current of the working motor is not greater than the initial current of the working motor, the present traveling speed of the autonomous device is not greater than the initial traveling speed of the autonomous device, and the present traveling speed of the autonomous device is not less than the activation speed of the autonomous device, the activation speed of the autonomous device may be determined as the first speed value. After the first speed value is determined, step 103 may be executed.

Illustratively, assuming that a previous current of the working motor is 20 A, A denotes 30 A, B denotes 60 A, C denotes 20 A, D denotes 2, Kₚ denotes 1.0, Kᵢ denotes 0.1, K_{d} denotes 0.2, and the time difference is 0.5 s, the previous

$$E ( t ) = {( \frac{20 - 60}{20} )}^{2} = 4 ,$$

the present

$$E ( t ) = {( \frac{30 - 60}{20} )}^{2} = 2.25 , and$$

$${\int }_{0}^{t} E ( τ ) d τ = {\int }_{0}^{0.5} 2.25 d τ = 1.1 25.$$

Since 1.125 is greater than the integral upper limit 0.5, the final integral result is 0.5,

$$\frac{dE ( t )}{dt} = \frac{2.25 - 4}{0.5} = - 3.5 ,$$

and the speed adjustment proportion=1−(1.0*2.25+0.1*1.125+0.2*(−3.5))=−0.675. The first speed value may be determined according to the minimum traveling speed of the autonomous device.

Illustratively, assuming that a previous current of the working motor is 20 A, A denotes 40 A, B denotes 30 A, C denotes 20 A, D denotes 2, Kₚ denotes 1.0, Kᵢ denotes 0.1, K_{d} denotes 0.2, and the time difference is 0.5 s, the previous

$$E ( t ) = {( \frac{20 - 30}{20} )}^{2} = 0.25 ,$$

the present

$$E ( t ) = {( \frac{40 - 30}{20} )}^{2} = 0.25 ,$$

$${\int }_{0}^{t} E ( τ ) d τ = {\int }_{0}^{0.5} 0.25 d τ = 0.125 , \frac{dE ( t )}{dt} = \frac{0.25 - 0.25}{0.5} = 0 ,$$

and the speed adjustment proportion=1−(1.0*0.25+0.1*0.125+0.2*0)=0.7375. Thus, the first speed value=0.7375*absolute value of present traveling speed. It can be seen that the autonomous device is decelerated.

It should be understood that in a working process of the autonomous device, Kₚ, Kᵢ, and K_{d} of the PID algorithm may be fixed or adjusted according to the actual condition, and finally an optimal result is taken as a final value.

It should be understood that the flow shown in FIG. 4 is to illustratively describe determination of the first speed value through the preset speed adjustment algorithm, which is not limitative. Illustratively, steps B1 and B2 may be executed after steps B3-B6. Illustratively, the preset speed adjustment algorithm may be another preset speed adjustment algorithm. In this case, steps B1, B2, and B7 may not be executed, and step B8 may be replaced by the step that the speed adjustment proportion is determined according to the present current of the working motor through another preset speed adjustment algorithm. Illustratively, steps B3-B6 may not be executed. Illustratively, steps B9 and B10 may not be executed. Illustratively, steps B9 and B10 and steps B10-B20 may not be executed. Illustratively, steps B13-B17 may not be executed. In this case, step B12 may be replaced by the step that the first speed value is determined according to the speed adjustment proportion and the present traveling speed of the autonomous device.
103, the working current of the traveling motor is adjusted, and the traveling speed value of the autonomous device is caused to reach the first speed value.

After the first speed value is determined, the working current of the traveling motor may be adjusted, and the traveling speed value of the autonomous device is caused to reach the first speed value. To be specific, the traveling speed value of the autonomous device is adjusted to the first speed value by adjusting the working current of the traveling motor.

In the method for adjusting a speed described in FIG. 1, the autonomous device including the traveling motor and the working motor acquires the present current of the working motor, determines the first speed value according to the present current of the working motor through the preset speed adjustment algorithm, adjusts the working current of the traveling motor, and causes the traveling speed of the autonomous device to reach the first speed value. It can be seen that the traveling speed of the autonomous device may be adjusted according to the current of the working motor of the autonomous device. Thus, the flexibility of speed adjustment can be improved. In addition, the traveling speed of the autonomous device may be adjusted according to the current of the working motor of the autonomous device. Thus, overload of the autonomous device can be avoided, working efficiency, balance, and stability of the autonomous device can be improved, and power consumption of the autonomous device can be reduced.

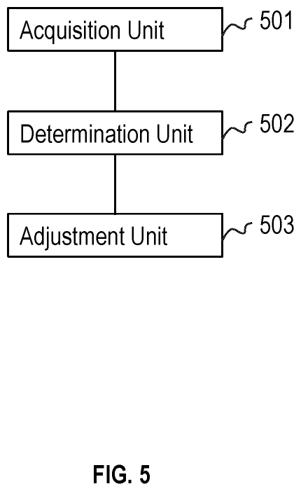

With reference to FIG. 5, a schematic structural diagram of a device for adjusting a speed disclosed in the embodiments of the present disclosure is shown in FIG. 5. The device for adjusting a speed may be applied to the autonomous device, where the autonomous device includes a traveling motor and a working motor. As shown in FIG. 5, the device for adjusting a speed may include:
an acquisition unit 501 configured to acquire a present current of the working motor;
a determination unit 502 configured to determine a first speed value according to the present current of the working motor through a preset speed adjustment algorithm; and
an adjustment unit 503 configured to adjust a working current of the traveling motor, and cause a traveling speed value of the autonomous device to reach the first speed value.

In some embodiments, the determination unit 502 is specifically configured to:
determine a speed adjustment proportion according to the present current of the working motor through the preset speed adjustment algorithm; and
determine the first speed value according to the speed adjustment proportion and a present traveling speed of the autonomous device.

In some embodiments, the determination unit 502 determines the first speed value according to the speed adjustment proportion and the present traveling speed of the autonomous device as follows:
in a case where the speed adjustment proportion is greater than or equal to 0, and the present current of the working motor is greater than an initial current of the working motor or the present traveling speed of the autonomous device is greater than an initial traveling speed of the autonomous device, the first speed value is determined according to the speed adjustment proportion and the present traveling speed of the autonomous device.

In some embodiments, the determination unit 502 is further configured to:
determine, in a case where the speed adjustment proportion is less than 0, the first speed value according to a minimum traveling speed of the autonomous device;
determine, in a case where the speed adjustment proportion is greater than or equal to 0, the present current of the working motor is not greater than an initial current of the working motor, the present traveling speed of the autonomous device is not greater than an initial traveling speed of the autonomous device, and the present traveling speed of the autonomous device is less than an activation speed of the autonomous device, a second speed value as the first speed value, where the second speed value is a preset traveling speed value of the autonomous device; and
determine, in a case where the speed adjustment proportion is greater than or equal to 0, the present current of the working motor is not greater than an initial current of the working motor, the present traveling speed of the autonomous device is not greater than an initial traveling speed of the autonomous device, and the present traveling speed of the autonomous device is not less than an activation speed of the autonomous device, the activation speed of the autonomous device as the first speed value.

In some embodiments, the determination unit 502 determines the first speed value according to the speed adjustment proportion and the present traveling speed of the autonomous device as follows:
a third speed value is determined according to the speed adjustment proportion and the present traveling speed of the autonomous device; and
in a case where the third speed value is less than or equal to a second speed value and greater than or equal to a minimum traveling speed of the autonomous device, the third speed value is determined as the first speed value, where the second speed value is a preset traveling speed value of the autonomous device.

The determination unit 502 is further configured to:
determine, in a case where the third speed value is greater than the second speed value, the second speed value as the first speed value; and
determine, in a case where the third speed value is less than the minimum traveling speed of the autonomous device, the first speed value according to the minimum traveling speed of the autonomous device.

In some embodiments, the acquisition unit 501 is specifically configured to acquire, in a case where a present traveling speed of the autonomous device is greater than or equal to the minimum traveling speed of the autonomous device, the present current of the working motor.

The determination unit 502 is further configured to:
determine, in a case where the present traveling speed of the autonomous device is less than the minimum traveling speed of the autonomous device, a difference between the present traveling speed of the autonomous device and the second speed value, where the second speed value is a preset traveling speed value of the autonomous device;
determine, in a case where the difference is less than a speed threshold, the second speed value as the first speed value;
determine, in a case where the difference is not less than a speed threshold and the present traveling speed of the autonomous device is greater than the second speed value, the difference between the present traveling speed of the autonomous device and the speed threshold as the first speed value; and
determine, in a case where the difference is not less than a speed threshold and the present traveling speed of the autonomous device is not greater than the second speed value, a sum of the present traveling speed of the autonomous device and the speed threshold as the first speed value.

In some embodiments, the determination unit 502 determines the first speed value according to the present current of the working motor through the preset speed adjustment algorithm as follows:
in a case where the present current of the working current is within a threshold range, the first speed value is determined according to the present current of the working motor through the preset speed adjustment algorithm.

In some embodiments, the determination unit 502 is further configured to determine, in a case where the present traveling speed of the autonomous device is greater than or equal to the minimum traveling speed of the autonomous device, a time difference according to current time and a previous time stamp.

The determination unit 502 is specifically configured to determine, in a case where the time difference is greater than 0 and less than or equal to 1, the first speed value according to the present current of the working motor through the preset speed adjustment algorithm.

The determination unit 502 is further configured to determine, in a case where the time difference is equal to 0, a second speed value as the first speed value, where the second speed value is a preset traveling speed value of the autonomous device.

Those skilled in the art can clearly understand that for convenience and conciseness of descriptions, reference can be made to the corresponding processes in the above method embodiments for specific working processes of the device for adjusting a speed, the acquisition unit 501, the determination unit 502, and the adjustment unit 503 described above, which will not be repeated herein.

In the plurality of embodiments provided by the present disclosure, units may be coupled in an electrical form, a mechanical form, etc.

Also, each function unit in the embodiments of the present disclosure can be integrated into a processing unit. Alternatively, each unit can be physically separated. Alternatively, two or more units can be integrated into one unit. The above integrated unit can be implemented in a form of hardware or a software function unit.

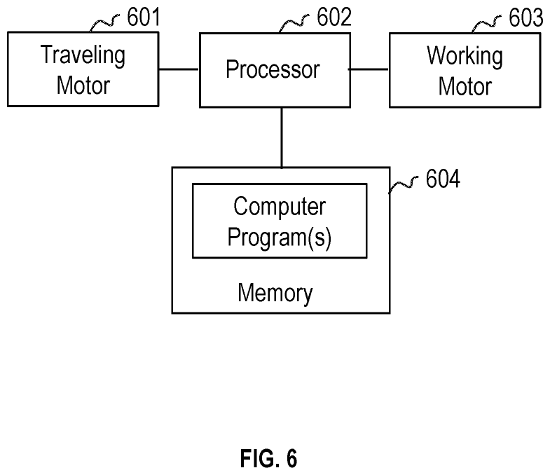

With reference to FIG. 6, a schematic structural diagram of an autonomous device disclosed in the embodiments of the present disclosure is shown in FIG. 6. As shown in FIG. 6, the autonomous device may include a traveling motor 601, a working motor 602, a processor 603, and a memory 604. The memory 604 may store one or more computer programs. The one or more computer programs are configured to execute the method as described in the foregoing method embodiment. The memory 604 may exist alone or may be integrated with the processor 603.

The processor 603 may include one or more processing cores. The processor 603 may connect each part of an entire autonomous device through various interfaces and lines, and execute various functions of the autonomous device and data processing by running or executing instructions, programs, code sets, or instruction sets stored in the memory 604, and invoking data stored in the memory 604. Optionally, the processor 603 may be implemented in at least one hardware form of digital signal processing (DSP), a field-programmable gate array (FPGA), and a programmable logic array (PLA). The processor 603 may integrate one or a combination of a central processing unit (CPU), a graphics processing unit (GPU), and a modem. The CPU mainly processes an operating system, a user interface, and an application, etc. The GPU is responsible for rendering and drawing of display content. The modem is configured to process wireless communication. It can be understood that the above modem may be implemented through a communication chip separately instead of being integrated into the processor 603.

The memory 604 may include a random access memory (RAM) or a read-only memory (ROM). The memory 604 may be configured to store instructions, programs, code, code sets, or instruction sets. The memory 604 may include a program storage area and a data storage area. The program storage area may store instructions configured to implement the operating system, instructions configured to implement at least one function (such as a touch function, a sound playback function, and an image playback function), instructions configured to implement each method embodiment described above, etc. The data storage area may store data (such as a phone book, audio and video data, chat record data) created by the autonomous device in use, etc.

In a case where the computer program instructions stored in the memory 604 are executed, the processor 603 may be configured to execute various operations executed by the autonomous device in the method embodiment described above. Specifically, the processor controls the traveling motor according to the working motor to implement various operations executed by the autonomous device in the method embodiment described above. Reference can be made to the foregoing embodiments for the specific implementation of these operations, which will not be repeated herein.

A computer-readable storage medium is further disclosed in the embodiments of the present disclosure. The computer-readable storage medium stores computer program codes, where the computer program codes are invokable by the processor to execute various operations in the method embodiment described above. Reference can be made to the foregoing embodiments for the specific implementation of each operation described above, which will not be repeated herein.

The computer-readable storage medium may be a flash memory, an electrically erasable programmable read only memory (EEPROM), an erasable programmable read only memory (EPROM), a hard disk, an ROM, etc. Optionally, the computer-readable storage medium may include a non-transitory computer-readable storage medium. The computer-readable storage medium has a storage space for program codes executing any method steps in the above method. These computer program codes may be read from or written into one or more computer program products. The computer program codes may be compressed in an appropriate form, for example.

Finally, it should be noted that the above embodiments are merely used to describe the technical solutions of the present disclosure, and are not intended to limit the present disclosure. Although the present disclosure is described in detail with reference to the foregoing embodiments, those of ordinary skill in the art should understand that they still can make modifications to the technical solutions described in all the foregoing embodiments, or make equivalent substitutions to some technical features in the embodiments. These modifications or substitutions do not make the essence of the corresponding technical solutions depart from the spirit and scope of the technical solutions in the embodiments of the present disclosure.

1-20. (canceled)

21. A system for adjusting a speed of an autonomous device, the system comprising:
a traveling motor configured to drive the autonomous device;
a working motor configured to drive a working operation, the working motor being separate from and configured to operate concurrently with the traveling motor;
a memory storing instructions; and
a processor coupled to the traveling motor, the working motor, and the memory, wherein the instructions, when executed by the processor, cause the system to modulate a traveling speed of the autonomous device based on loading of the working motor by performing a process comprising:
acquiring a present current of the working motor during the working operation, the present current being indicative of the loading of the working motor;
determining a speed adjustment proportion based on the present current of the working motor using a speed adjustment algorithm;
determining a first speed value based on the speed adjustment proportion and a present traveling speed of the autonomous device; and
causing the autonomous device to travel at a traveling speed of the first speed value by adjusting a working current of the traveling motor.

22. The system of claim 21, wherein determining the speed adjustment proportion comprises:
determining a proportional result of the speed adjustment algorithm based on the present current of the working motor;
determining a derivative result and an integral result of the speed adjustment algorithm based on the proportional result; and
determining the speed adjustment proportion based on the proportional result, the derivative result, and the integral result.

23. The system of claim 22, wherein determining the proportional result comprises determining the proportional result based on the present current of the working motor, a steady-state current of the working motor, and a current control range of the working motor.

24. The system of claim 22, wherein determining the integral result comprises:
comparing an absolute value of the integral result to an integral upper limit; and
in response to the absolute value of the integral result being greater than the integral upper limit, setting the integral upper limit as the integral result for use in determining the speed adjustment proportion.

25. The system of claim 21, wherein the process comprises:
in response to the speed adjustment proportion being less than zero, determining the first speed value based on a minimum traveling speed of the autonomous device.

26. The system of claim 21, wherein determining the first speed value based on the speed adjustment proportion and the present traveling speed of the autonomous device comprises:
in response to the speed adjustment proportion being greater than or equal to zero, and either the present current of the working motor being greater than an initial current of the working motor or the present traveling speed being greater than an initial traveling speed of the autonomous device, determining the first speed value based on the speed adjustment proportion and the present traveling speed.

27. The system of claim 21, wherein determining the first speed value based on the speed adjustment proportion and the present traveling speed comprises:
determining a third speed value based on the speed adjustment proportion and the present traveling speed; and
in response to the third speed value being less than or equal to a second speed value and greater than or equal to a minimum traveling speed of the autonomous device, determining the third speed value as the first speed value, wherein the second speed value is a preset traveling speed value.

28. The system of claim 27, wherein the process comprises:
in response to the third speed value being greater than the second speed value, determining the second speed value as the first speed value; and
in response to the third speed value being less than the minimum traveling speed, determining the first speed value based on the minimum traveling speed.

29. The system of claim 21, wherein the process comprises:
determining whether an obstacle exists in a traveling direction of the autonomous device;
in response to determining that the obstacle exists in the traveling direction of the autonomous device, adjusting the working current of the traveling motor such that the traveling speed of the autonomous device is zero; and
in response to determining that no obstacle exists in the traveling direction of the autonomous device, determining whether the present traveling speed is less than a minimum traveling speed of the autonomous device.

30. The system of claim 21, wherein acquiring the present current of the working motor comprises:
acquiring the present current in response to the present traveling speed of the autonomous device being greater than or equal to a minimum traveling speed of the autonomous device.

31. The system of claim 21, wherein the process comprises:
in response to the present traveling speed of the autonomous device being less than a minimum traveling speed of the autonomous device, determining a difference between an absolute value of the present traveling speed and a second speed value, wherein the second speed value is a preset traveling speed value.

32. The system of claim 31, wherein the process comprises:
in response to the difference being less than a speed threshold, setting the second speed value as the first speed value.

33. The system of claim 31, wherein the process comprises:
in response to the difference being greater than or equal to a speed threshold and the absolute value of the present traveling speed being greater than the second speed value, determining a difference between the absolute value of the present traveling speed and the speed threshold as the first speed value.

34. The system of claim 21, wherein the autonomous device comprises a snow blower, a lawn mower, or a leaf-blower robot.

35. The system of claim 21, wherein the autonomous device comprises a snow blower, the process comprising:
determining a thickness of snow using a sensor of the autonomous device or a load condition of a snow auger of the snow blower; and
adjusting the traveling speed of the autonomous device based on the thickness of the snow.

36. The system of claim 21, wherein the process comprises:
in response to the present current of the working motor exceeding an over-current threshold, adjusting the working current of the traveling motor to cause the traveling speed of the autonomous device to be zero.

37. The system of claim 21, wherein the process comprises:
determining whether the autonomous device is performing a turning maneuver; and
in response to determining that the autonomous device is performing the turning maneuver, suspending the determining of the first speed value.

38. The system of claim 21, wherein the process comprises:
in response to the present traveling speed of the autonomous device being less than a maximum reverse traveling speed of the autonomous device, updating the maximum reverse traveling speed to the present traveling speed.

39. A method for operating an autonomous device, the autonomous device comprising a processor, a memory, a traveling motor configured to drive the autonomous device, and a working motor configured to drive a working operation, the working motor being separate from and configured to operate concurrently with the traveling motor, the method comprising:
acquiring, by the processor, a present current of the working motor during the working operation, the present current being indicative of loading of the working motor;
determining a speed adjustment proportion based on the present current of the working motor using a speed adjustment algorithm;
determining a first speed value based on the speed adjustment proportion and a present traveling speed of the autonomous device; and
causing the autonomous device to travel at a traveling speed of the first speed value by adjusting a working current of the traveling motor, thereby modulating the traveling speed of the autonomous device based on the loading of the working motor.

40. One or more non-transitory computer-readable storage media storing computer-readable instructions, wherein the computer-readable instructions, when executed by at least one processor, cause a system to execute a process comprising:
acquiring a present current of a working motor of the system, the working motor being configured to drive a working operation, the present current being indicative of loading of the working motor;
determining a speed adjustment proportion based on the present current of the working motor using a speed adjustment algorithm;
determining a first speed value based on the speed adjustment proportion and a present traveling speed of an autonomous device of the system; and
causing the autonomous device to travel at a traveling speed of the first speed value by adjusting a working current of a traveling motor, thereby modulating the traveling speed of the autonomous device based on the loading of the working motor, the traveling motor being configured to drive the autonomous device, the traveling motor being separate from and configured to operate concurrently with the working motor.
